(19) United States
(12) Patent Application Publication
(10) Pub. No.: US 2023/0107864 A1
(43) Pub. Date: Apr. 6, 2023

(54) SYSTEM AND METHOD FOR PROVIDING BROAD BAND LOCAL AREA NETWORK SERVICES AT A DWELLING

(71) Applicant: POYNTING ANTENNAS (PTY) LIMITED, Samrand, Centurion, Pretoria (ZA)

(72) Inventors: Andries Petrus Cronje FOURIE, Parkview, Johannesburg (ZA); Eduard Willem WALKER, Eldoraigne, Centurion, Pretoria (ZA)

(21) Appl. No.: 17/906,005

(22) PCT Filed: Mar. 3, 2021
(86) PCT No.: PCT/IB2021/051750

§ 371 Date: Sep. 9, 2022

(30) Foreign Application Priority Data
Mar. 11, 2020 (ZA) 2020/01522

(51) Int. Cl. H04W 16/28

(52) U.S. Cl. CPC H04W 16/28; H04W 84/12

(57) ABSTRACT

There is provided for a system (10) for providing local area network (LAN) services at a dwelling (12.6) which dwelling comprises an interior and an exterior on opposed sides of a targeted face (13) of the dwelling. The system comprises a wireless radio router (14) having an antenna (16). The targeted face comprises an electromagnetic wave transparent part (24.1). The wireless radio router with the antenna is located on the exterior of the dwelling and is in data communication with a backend (18) via a communications network (20). The antenna is associated with a radiation pattern (22) configured to illuminate the interior of the dwelling via the electromagnetic wave transparent part with electromagnetic waves from the exterior of the dwelling, to provide LAN services at the dwelling.

### INTRODUCTION AND BACKGROUND

This invention relates to a data communication system and method and more particularly to a system and method for providing broad band local area network (LAN) services at a dwelling.

It is known to provide LAN data services in a dwelling by providing from a backend, cabling, preferably optical fibre, up to an access point close to the dwelling. A wireless router is then located inside the dwelling and connected by cable to the access point. The wireless router enables communication between devices in the dwelling and the internet. In other known systems, the router inside the house may be connected to the backend by a wireless system, for example a system for providing communication services in a corridor, such as a street, as disclosed in the applicant's international patent application PCT/IB2018/050374 entitled “System and method for providing communication services on both sides of a corridor” which was published as WO 2018/142236 A1.

A disadvantage of the current systems is that the so-called “home-drop” stage or step, which comprises installation of the wireless router inside the dwelling, is unnecessary labour intensive and/or expensive for some applications. The installation requires access to the dwelling and the physical connection by cable of the router to the access point.

A second disadvantage of the current systems is that the wireless indoor router is located at a fixed position inside the dwelling and due to distance and obstacles, such as walls, inside the dwelling, the coverage inside the dwelling is erratic and signal levels vary considerably depending on position within the dwelling.

### OBJECT OF THE INVENTION

Accordingly, it is an object of the present invention to provide a communication system and method with which the applicant believes the aforementioned disadvantages may at least be alleviated or which may provide a useful alternative for the known systems and methods.

### SUMMARY OF THE INVENTION

According to the invention there is provided a system for providing local area network (LAN) services at a first dwelling having an interior and an exterior on opposed first and second sides respectively of a targeted face of the dwelling, the targeted face having a height and a width and comprising at least one electromagnetic wave transparent part, the system comprising:
a wireless router having at least a first antenna, the wireless router with at least first antenna being located on the exterior of the first dwelling;
the wireless router being in data communication with a backend via a communications network; and
the at least first antenna being associated with a first radiation pattern configured to illuminate the interior of the first dwelling with electromagnetic waves from the exterior of the first dwelling, in use, to provide LAN services at the first dwelling.

It is a fundamental property of antennas that the receiving pattern (sensitivity as a function of direction) of an antenna when used for receiving is identical to the far-field radiation pattern of the antenna when used for transmitting. This is a consequence of the reciprocity theorem of electro-magnetism. Therefore, references in this specification to radiation patterns of the antenna can be viewed as either transmitting or receiving, whichever is more convenient.

The electromagnetic waves may be radio waves which, in use, pass through the at least one electromagnetic wave transparent part, to illuminate the interior of the first dwelling.

The first radiation pattern may be configured and directed to cover at least two electromagnetic wave transparent parts of the first dwelling. Such parts may comprise external windows and even doors of the first dwelling.

The first radiation pattern may be configured such that maximum power density is provided towards the at least two electromagnetic wave transparent parts of the first dwelling and preferably optimised to distribute power uniformly to such parts.

The at least first antenna may be mounted at a distance d away from a closest point of the targeted face, such that 5 m<d<30 m.

The wireless router may be mounted on a mast externally of the first dwelling. The mast may be a dedicated mast or the mast may also carry other apparatus.

The first radiation pattern may further be configured such that energy in directions away from the first dwelling and also towards areas of the dwelling which offer low electromagnetic penetration into the dwelling, is minimised.

The first radiation pattern may have an azimuth beam-width associated with an azimuth beam-width angle and an elevation beam-width associated with an elevation beam-width angle, the azimuth beam-width angle may be greater than the elevation beam-width angle, the elevation beam-width angle being optimised to illuminate the height of the targeted face and the azimuth beam-width angle being chosen to cover a part of the width of the targeted face comprising the at least two electromagnet wave transparent parts.

The router may support any suitable data networking technology, such as those based on the IEEE 802.11 family of standards, which are commonly used for local area networking of devices and Internet access, such as the technology referred to as Wi-Fi™.

In some embodiments, the wireless router may comprise the first antenna and a second antenna associated with a second radiation pattern configured to illuminate a second dwelling from exterior the second dwelling and to provide LAN services at the second dwelling.

In other embodiments, the wireless router and further wireless routers may be provided on the mast, each further wireless router comprising a respective first antenna, each respective first antenna being associated with a respective radiation pattern configured to illuminate a respective further dwelling from an exterior of the respective further dwelling and to provide LAN services at the respective further dwelling.

According to another aspect of the invention there is provided a method of providing broad band local area network services at a first dwelling, the method comprising: illuminating an interior of the first dwelling from an exterior of the first dwelling with wireless electromagnetic waves of a wireless router which is in data communications with a backend.

The method further comprising utilising at least one electromagnetic wave transparent part of the first dwelling to transmit the electromagnetic waves from the exterior to the interior of the first dwelling.

### BRIEF DESCRIPTION OF THE ACCOMPANYING DIAGRAMS

The invention will now further be described, by way of example only, with reference to the accompanying diagrams wherein:

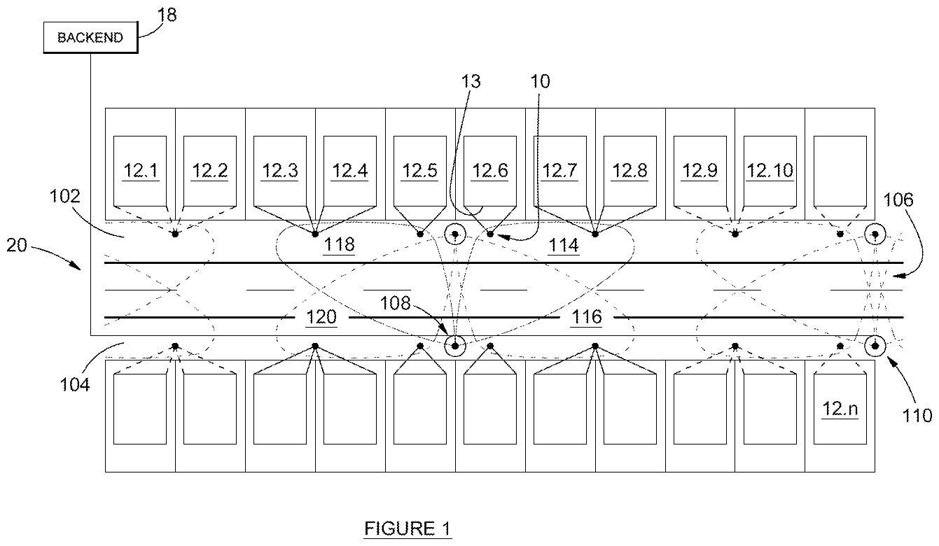

FIG. 1 is a diagrammatic plan view of an example embodiment of a system for providing broad band LAN services at dwellings;

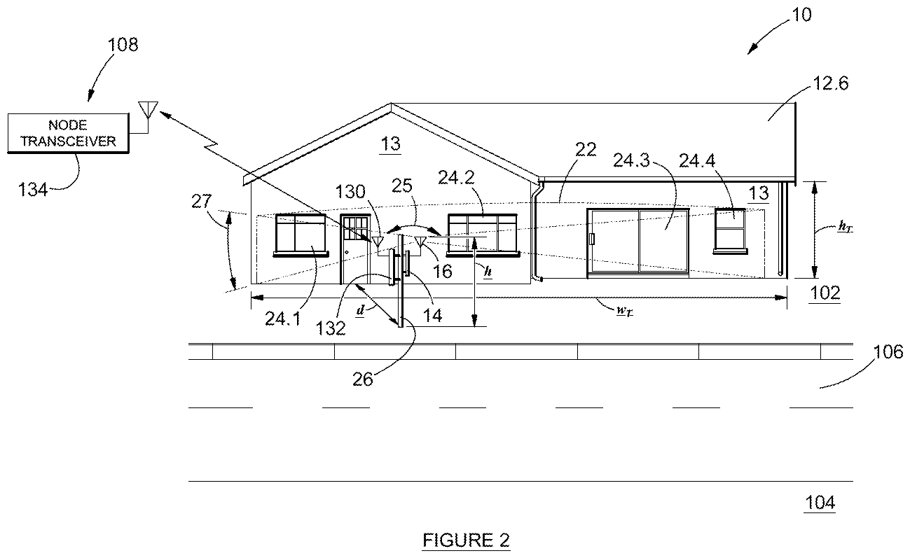

FIG. 2 is a more detailed view of a “home-drop” section of the system;

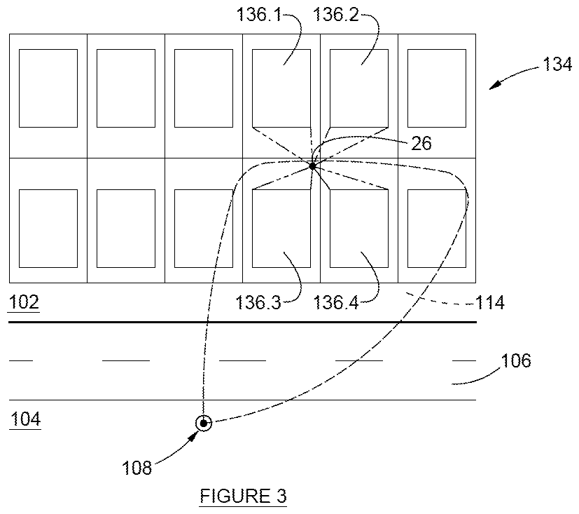

FIG. 3 is a plan view of another example embodiment of the system;

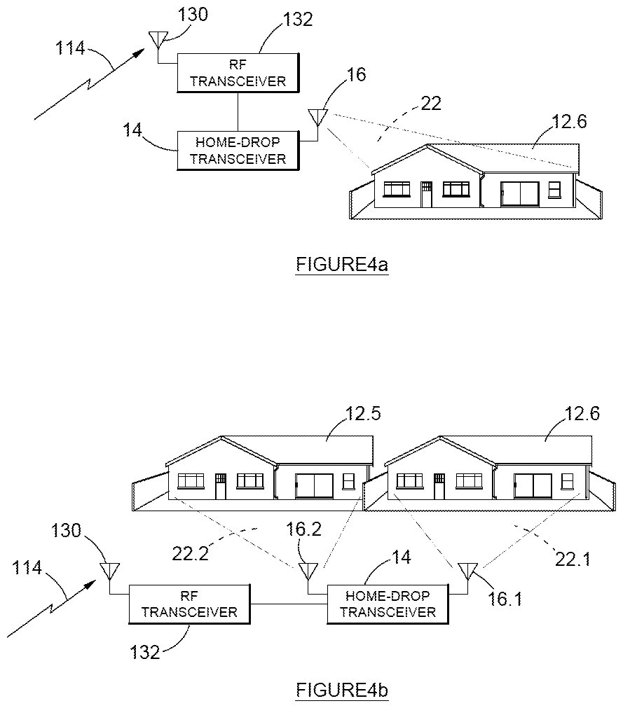

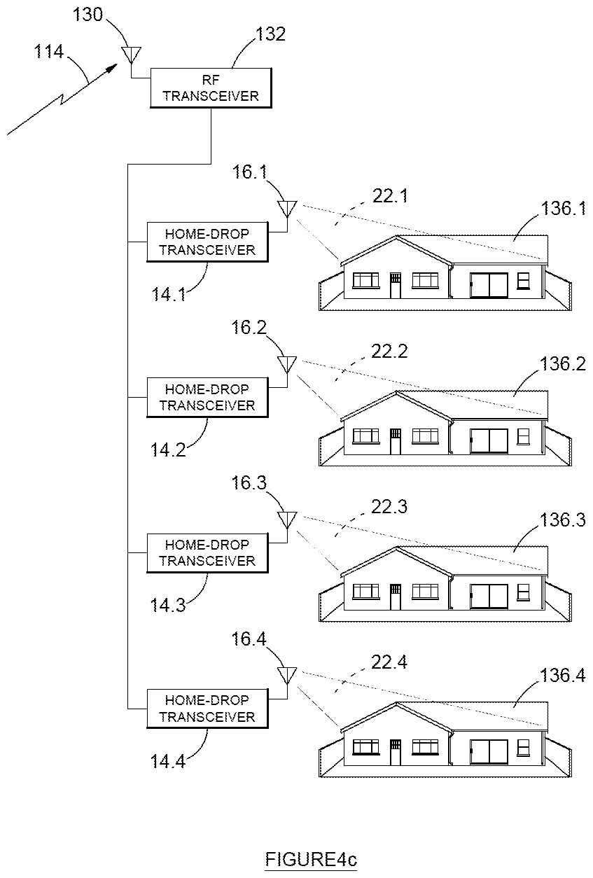

FIGS. 4(a) to 4(c) are more detailed representations of the “home-drop” sections of various example embodiments of the system.

### DESCRIPTION OF A PREFERRED EMBODIMENT OF THE INVENTION

An example embodiment of a system for providing broad band local area network (LAN) services at a dwelling 12.6 of a plurality of dwellings 12.1 to 12.n is generally designated by the reference numeral 10 in FIGS. 1 and 2. The first dwelling 12.6 has an interior and an exterior on opposed first and second sides respectively of a targeted face 13 of the dwelling.

The system 10 comprises a wireless home-drop transceiver, typically in the form of a wireless router 14 comprising at least a first antenna 16. The wireless router 14 with at least first antenna 16 are mounted externally of the dwelling 12.6. The wireless router 14 is in data communication with a backend 18 via a communications network 20, as will be described in more detail below. The at least first antenna 16 is associated with a first radiation pattern 22 configured to illuminate the interior of the first dwelling 12.6 with electromagnetic waves from the exterior of the first dwelling and to provide LAN services at the first dwelling 12.6.

Referring to FIG. 2, the targeted face has a height h_{T} and a width w_{T} and comprises electromagnetic wave transparent parts, such as external glass windows and doors 24.1 to 24.4. The electromagnetic wave transparent parts, in use, transmit the electromagnetic waves between the exterior and the interior of the first dwelling 12.6. In the preferred embodiment, the electromagnetic waves are radio waves which pass through the at least one electromagnetic wave transparent part, to illuminate the interior of the first dwelling 12.6.

The dwelling may comprise different rooms within the dwelling and the rooms may be separated by internal walls providing low or unsatisfactory electromagnetic wave penetration. The electromagnetic wave transparent parts, in the form of external glass windows and doors 24.1 to 24.4, may be provided in respective outside wall parts of the rooms forming part of the targeted face. The windows and doors transmit electromagnetic waves to and from the router 14, so that electronic devices within the different rooms are connected by a wireless LAN to the router 14 externally of the dwelling via the parts 24.1 to 24.4 and thereby also to one another.

The at least one antenna may be mounted at a distance d away from a closest point of the targeted face 13, such that 5 m<d<30 m and at a height h of about 2-4 meters above ground level for a typical single storey dwelling, such as dwelling 12.6.

The wireless router 14 and antenna 16 are mounted on a mast 26 externally of the first dwelling. The mast may be a dedicated mast or the mast may also carry other apparatus.

The radiation pattern 22 is configured such that maximum power density is provided at external areas of the first dwelling 12.6 which offer highest electromagnetic penetration, such as the windows and doors 24.1 to 24.4, and preferably optimised to distribute power uniformly to such external areas. The radiation pattern 22 is further configured such that energy in directions away from the first dwelling 12.6 and also towards areas of the first dwelling 12.6 which offer low electromagnetic penetration into the first dwelling 12.6, are minimised.

The radiation pattern 22 may have an azimuth beam-width associated with an azimuth beam-width angle 25 and an elevation beam-width associated with an elevation beam-width angle 27. The azimuth beam-width angle may be greater than the elevation beam-width angle. The elevation beam-width angle 27 may be optimised to illuminate the height of the targeted face 13. The azimuth beam-width angle 25 is preferably chosen to include various of the electromagnetic wave transparent parts 24.1 to 24.4 of the targeted face 13 of the dwelling.

The wireless router 14 may comprise a Wi-Fi™ router.

In some embodiments (not shown) the wireless router 14 is connected to the backend 18 by an access point of a cabled network, such as a fibre/cable kerb network, such as FTTx or other cable-based distribution network, such as ADSL etc.

In other embodiments, the wireless router 14 may be connected to the backend 18 by an at least partially wireless system, such as a system for providing communication services in a corridor as disclosed in the applicant's international patent application PCT/IB2018/050374 entitled “System and method for providing communication services on both sides of a corridor” which was published as WO 2018/142236 A1. The contents of the specification of the applicant's international patent application PCT/IB2018/050374 are incorporated herein by this reference. Briefly and referring to FIG. 1 hereof, such a system 100 for providing communication services to user stations or dwellings 12.1 to 12.n which are spaced on first and second opposed sides 102, 104 of an elongate corridor 106, such as street, comprises at least a first radio frequency transceiver node 108 and a spaced second radio frequency transceiver node 110. The nodes drive respective radiation patterns comprising at least one of first, second, third and fourth lobes 114, 116, 118 and 120 having respective main axes. The arrangement is such that in respect of the first corridor node 108, the main axis of the first lobe 114 is directed towards a first region which is on the first side 102 of the corridor, to illuminate stations 12.6 to 12.8 on the first side; the main axis of the second lobe 116 is directed towards a second region which is on the second side 104 of the corridor, to illuminate stations on the second side; the main axis of the third lobe 118 is directed towards a third region which is on the first side 102, to illuminate stations 12.3 to 12.5 on the first side; and the main axis of the fourth lobe 120 is directed towards a fourth region to illuminate stations on the second side 104. At each user station or dwelling there is provided a high gain, directional antenna externally of the dwelling and directed at the node servicing the dwelling, in this case first node 108. As stated in the introduction of this specification and in presently known systems, the directional antenna is connected to a Wi-Fi™ router inside the dwelling 12.6.

In the example embodiment of the system 10, the directional antenna, which is designated 130, is mounted on mast 26 which is located externally of and spaced from dwelling 12.6. The directional antenna is connected to a transceiver 132 which cooperates with a transceiver 134 at first node 108.

The transceiver 132 is connected to the router 14 having antenna 16. Both the router 14 and antenna 16 are mounted on the mast 26. As stated above, the antenna 16 is associated with a first radiation pattern 22 configured to illuminate the dwelling 12.6 from the exterior of the dwelling 12.6 and to provide LAN services at the dwelling 12.6. Due to the electromagnetic wave transparent external windows 24.1 to 24.4, the electromagnetic waves from and to the router 14 are expected to be of sufficient quality to provide broad band LAN services to devices (not shown) distributed in the dwelling 12.6.

In FIG. 3 there is illustrated relevant parts of another example embodiment of the system 10. In this example embodiment, lobe 114 of node 108 is configured such that it covers an area extending into a block 134 of dwellings adjacent street 106. The mast 26 carrying the directional antenna 130, the transceiver 132 and routers 14 with respective antennas 16 is positioned such that the respective antennas 16 illuminate respective dwellings 136.1 to 136.4 in the block from a single mast 26.

In FIGS. 4(a) to 4(c) there are various other example embodiments of the system 10, which are self-explanatory. The embodiment of FIG. 4(a) corresponds with that of FIG. 2 and is merely an alternative illustration thereof.

In FIG. 4(b) the home-drop receiver 14 on the mast is connected to first and second antennas 16.1 and 16.2. The first antenna 16.1 is associated with a first radiation pattern 22.1 configured to illuminate dwelling 12.6 from the exterior of the dwelling with electromagnetic waves and to provide LAN services at the dwelling 12.6. The second antenna 16.2 is associated with a second radiation pattern 22.2 configured to illuminate dwelling 12.5 with electromagnetic waves from the exterior of the dwelling 12.5 and to provide LAN services at the dwelling 12.5.

The embodiment of FIG. 4(c) comprises a router 14.1 to 14.4 for each of a plurality of dwellings 136.1 to 136.4. Each router comprises a respective antenna 16.1 to 16.4 and each antenna is associated with a respective radiation pattern 22.1 to 22.4 configured to illuminate a respective dwelling 136.1 to 136.4 from the exterior of the respective dwelling and to provide LAN services at the respective dwelling.

It will be appreciated that there are many variations in detail possible on the invention as herein defined and/or described, without departing from the scope and spirit of this disclosure.

For example, the backend 18 may be connected to the router 14 via a conventional wireless base station (not shown), such as an LTE/4G/5G base station, using a different antenna for a link to the backend.

Repeater or retransmitting units (not shown) may be mounted close to windows or doors 24.1 to 24.4 or just exterior of the dwelling 12.6, to further increase coverage or allow for data connectivity to the router 14 via such units.

1. A system for providing local area network (LAN) services at a first dwelling having an interior and an exterior on opposed first and second sides respectively of a targeted face of the dwelling, the targeted face having a height and a width and comprising at least one electromagnetic wave transparent part, the system comprising:
a wireless router having at least a first antenna, the wireless router with at least first antenna being located on the exterior of the first dwelling;
the wireless router being in data communication with a backend via a communications network; and
the at least first antenna being associated with a first radiation pattern configured to illuminate the interior of the first dwelling with electromagnetic waves from the exterior of the first dwelling, in use, to provide LAN services at the first dwelling.

2. The system as claimed in claim 1 wherein the electromagnetic waves are radio waves which, in use, pass through the at least one electromagnetic wave transparent part, to illuminate the interior of the first dwelling.

3. The system as claimed in claim 1 wherein the first radiation pattern is configured and directed to cover at least two electromagnetic wave transparent parts.

4. The system as claimed in claim 1 wherein the first radiation pattern is configured such that maximum power density is provided towards the at least one electromagnetic wave transparent part.

5. The system as claimed in claim 1 wherein the at least first antenna is mounted at a distance d away from a closest point of the targeted face, such that 5 m<d<30 m.

6. The system as claimed in claim 1 wherein the wireless router is mounted on a mast on the exterior of the first dwelling.

7. The system as claimed in claim 6 wherein the mast is a dedicated mast.

8. The system as claimed in claim 1 wherein the first radiation pattern is configured such that power in directions away from the first dwelling and in directions towards at least some areas of the targeted face which are not electromagnetic wave transparent, is minimised.

9. The system as claimed in claim 3 wherein the first radiation pattern has an azimuth beam-width which is associated with an azimuth beam-width angle and an elevation beam-width which is associated with an elevation beam-width angle, wherein the azimuth beam-width angle is greater than the elevation beam-width angle, the elevation beam-width angle being optimised to illuminate the height of the targeted face and the azimuth beam-width angle being chosen to cover at least a part of the width of the targeted face comprising the at least two electromagnetic wave transparent parts.

11. The system as claimed in claim 10 wherein the router supports a data networking technology based on IEEE 802.11 family of standards.

12. The system as claimed in claim 1 wherein the wireless router comprises the first antenna and a second antenna associated with a second radiation pattern configured to illuminate a second dwelling from exterior the second dwelling and to provide LAN services at the second dwelling.

13. The system as claimed in claim 3 wherein the wireless router and further wireless routers are provided on the mast, each further wireless router comprising a respective first antenna, wherein each respective first antenna is associated with a respective radiation pattern configured to illuminate a respective further dwelling from an exterior of the respective further dwelling and to provide LAN services at the respective further dwelling.

14. A method of providing local area network services at a first dwelling, the method comprising: illuminating an interior of the first dwelling from an exterior of the first dwelling with wireless electromagnetic waves of a wireless router on the exterior of the first dwelling and which is in data communication with a backend.

15. The method as claimed in claim 14 comprising utilising at least one electromagnetic wave transparent part of the first dwelling to transmit the electromagnetic waves from the exterior to the interior of the first dwelling.
